(19) United States
(12) Patent Application Publication
(10) Pub. No.: US 2026/0369065 A1
(43) Pub. Date: Nov. 19, 2026

(54) AUTOMATIC ORGANIZATIONAL AND TRACKING SYSTEM

(71) Applicant: Ohio State Innovation Foundation, Columbus, OH (US)

(72) Inventors: Dan Wisniewski, Columbus, OH (US); Michael Terveer, Columbus, OH (US); Aspen Schneller, Columbus, OH (US); Sean Starrett, Columbus, OH (US); Richard Cazares, Columbus, OH (US)

(21) Appl. No.: 19/676,330

(22) Filed: May 13, 2026

Related U.S. Application Data
(60) Provisional application No. 63/840,353, filed on Jul. 8, 2025.
(60) Provisional application No. 63/804,969, filed on May 13, 2025.

(51) Int. Cl. G06V 20/52; G06V 10/75; G06V 10/764; G06V 40/20; G06V 10/12

(52) U.S. Cl. CPC G06V 20/52; G06V 10/751; G06V 10/764; G06V 40/20; G06V 10/12

(57) ABSTRACT

An example method includes capturing a first image of a scene by an imaging device, constructing a first object map using the first image, where the first object map comprises a first plurality of detected objects. The method further includes capturing a second image of the scene by the imaging device, constructing a second object map using the second image, where the second object map includes a second plurality of detected objects, identifying a change in the scene by comparing the first object map and the second object map, determining an action based on the change in the scene, and outputting the action to a remote computing device.

### CROSS-REFERENCE TO RELATED APPLICATIONS

This application claims the benefit of U.S. provisional patent application No. 63/804,969, filed on May 13, 2025, and titled “ORGANIZATION SYSTEM,” and U.S. provisional patent application No. 63/840,353, filed on Jul. 8, 2025, and titled “ORGANIZATION SYSTEM” the disclosures of which are expressly incorporated herein by reference in their entireties.

### BACKGROUND

Home automation devices, systems and methods aim to simplify and/or automate tasks in homes and businesses. Examples of home automation systems include smart thermostats, robot vacuums, and smart lighting. Improvements to home automation systems, devices, and methods can benefit users.

### SUMMARY

In some aspects, implementations of the present disclosure include a system including: an imaging device; a processor and a memory operably coupled to the processor, the memory having computer-executable instructions stored thereon that, when executed by the processor, cause the processor to: capture a first image or set of images (e.g., a “scan”) of a scene by an imaging device construct a first object map using the first image, wherein the first object map includes a first plurality of detected objects; capture a second image of the scene by the imaging device, construct a second object map using the second image, wherein the second object map includes a second plurality of detected objects; identify a change in the scene by comparing the first object map and the second object map; determine an action based on the change in the scene; and output the action to a remote computing device. Optionally, the action can include adding a task, updating a layout, removing a task, locating a forgotten item, and/or detecting movement. The action can be determined by an algorithm configured to convert an object map into a task list and/or room layout. Optionally, the system can store a memory or memories of the scene to determine daily tasks and/or locate forgotten items.

In some aspects, implementations of the present disclosure include a system, wherein the imaging device includes a 2-D camera module.

In some aspects, implementations of the present disclosure include a system, wherein the computer-executable instructions further include instructions that, when executed by the processor, cause the processor to: detect that an occupant of the scene has left the scene.

In some aspects, implementations of the present disclosure include a system, wherein the remote computing device includes a mobile computing device.

In some aspects, implementations of the present disclosure include a system, wherein the computer-executable instructions further include instructions that, when executed by the processor, cause the processor to: classify the first plurality of detected objects and second plurality of detected objects into a plurality of object categories.

In some aspects, implementations of the present disclosure include a system, wherein the computer-executable instructions further include instructions that, when executed by the processor, cause the processor to: classify the first plurality of detected objects and second plurality of detected objects into a plurality of object categories by a trained machine learning classifier.

In some aspects, implementations of the present disclosure include a system, further including a directional indicator operably coupled to the processor, wherein the directional indicator is configured to output a directional indication (e.g., a calculated path, set of 2D image projections, and/or directional indications to the user in real time) based on the action.

In some aspects, implementations of the present disclosure include a system, wherein the first object map includes a baseline object map, and the second object map includes a change from the baseline object map. Optionally, the maps are generated using a series of image captures in different camera positions using a scanning algorithm. The series of images can be merged to count detected objects once per scan. This algorithm can optionally assess a confidence level that a detected object is present and/or correctly classified by the machine learning classifier.

In some aspects, implementations of the present disclosure include a computer-implemented method including: capturing a first image or set of images (e.g., a “scan”) of a scene by an imaging device, constructing a first object map using the first image, wherein the object map includes a first plurality of detected objects; capturing a second image of the scene by the imaging device, constructing a second object map using the second image, wherein the object map includes a second plurality of detected objects; identifying a change in the scene by comparing the first object map and the second object map; determining an action based on the change in the scene; and outputting the action to a remote computing device.

In some aspects, implementations of the present disclosure include a computer-implemented method, wherein the imaging device includes a 2-D camera module.

In some aspects, implementations of the present disclosure include a computer-implemented method, further including detecting that an occupant of the scene has left the scene.

In some aspects, implementations of the present disclosure include a computer-implemented method, wherein the remote computing device includes a mobile computing device.

In some aspects, implementations of the present disclosure include a computer-implemented method, further including classifying the first plurality of detected objects and second plurality of detected objects into a plurality of object categories.

In some aspects, implementations of the present disclosure include a computer-implemented method, further including classifying the first plurality of detected objects and second plurality of detected objects into a plurality of object categories by a trained machine learning classifier.

In some aspects, implementations of the present disclosure include a computer-implemented method, further including controlling a directional indicator to output a directional indication based on the action.

In some aspects, implementations of the present disclosure include a computer-implemented method, wherein the directional indicator includes a laser coupled to a gimbal.

In some aspects, implementations of the present disclosure include a computer-implemented method, wherein the first object map includes a baseline object map, and the second object map includes a change from the baseline object map.

In some aspects, implementations of the present disclosure include a non-transitory computer-readable medium having instructions thereon, that when executed by one or more processors, cause the one or more processors to: capture a first image of a scene by an imaging device construct a first object map using the first image, wherein the object map includes a first plurality of detected objects; capture a second image of the scene by the imaging device, wherein the object map includes a second plurality of detected objects; construct a second object map using the second image; identify a change in the scene by comparing the first object map and the second object map; determine an action based on the change in the scene; and output the action to a remote computing device.

In some aspects, implementations of the present disclosure include a non-transitory computer-readable medium, wherein the instructions further include instructions that, when executed by the one or more processors, cause the one or more processors to: classify the first plurality of detected objects and second plurality of detected objects into a plurality of object categories by a trained machine learning classifier.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates an example system according to implementations of the present disclosure.

FIG. 2 illustrates an example method that can be implemented by the system of FIG. 1, according to implementations of the present disclosure.

FIG. 3 illustrates an example computing device.

FIG. 4 illustrates an example stationary implementation of the system of FIG. 1, according to implementations of the present disclosure.

FIG. 5 illustrates an example method of operating the system of FIG. 4, according to implementations of the present disclosure.

FIG. 6 illustrates example user interfaces that can be implemented by the system of FIG. 4, according to implementations of the present disclosure.

FIG. 7 illustrates example housing shapes that can be used to implement the system of FIG. 4, according to implementations of the present disclosure.

FIG. 8 illustrates another example system according to implementations of the present disclosure.

FIG. 9 illustrates an example first step of a method that can be implemented by the system of FIG. 8, according to implementations of the present disclosure.

FIG. 10 illustrates an example second step of the method of FIG. 9, according to implementations of the present disclosure.

FIG. 11 illustrates an example third step of the method of FIGS. 9 and 10, according to implementations of the present disclosure.

FIG. 12 illustrates another example method that can be implemented by the systems described herein, according to implementations of the present disclosure.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from "about" one particular value, and/or to "about" another particular value. When such a range is expressed, an aspect includes from the one particular value and/or to the other particular value. Similarly, when values are expressed as approximations, by use of the antecedent "about," it will be understood that the particular value forms another aspect. It will be further understood that the endpoints of each of the ranges are significant both in relation to the other endpoint, and independently of the other endpoint. While implementations will be described for home organization, it will become evident to those skilled in the art that the implementations are not limited thereto, but are applicable for any kind of organization, tracking, and/or task management system.

As used herein, the terms "about" or "approximately" when referring to a measurable value such as an amount, a percentage, and the like, is meant to encompass variations of ±20%, ±10%, ±5%, or ±1% from the measurable value.

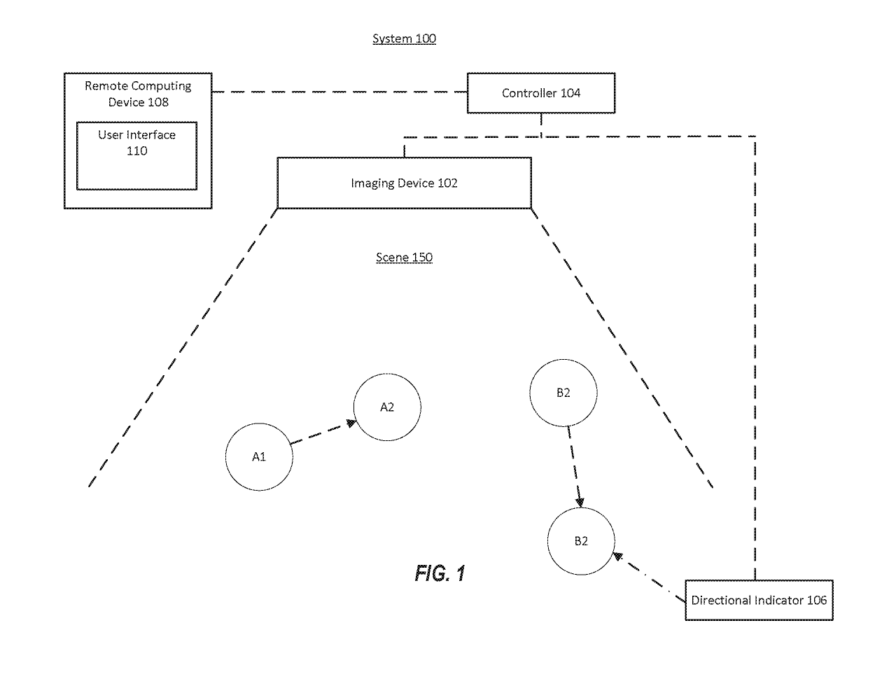

With reference to FIG. 1, implementations of the present disclosure include systems for home automation, including systems that can automatically analyze the state of a scene 150 (e.g., a room) and determine actions that should be completed based on the state of the scene 150 (e.g., moving items back to their original locations, cleaning up debris). In the example scene 150 shown in FIG. 1, objects A and B move from first positions A1 and B1 to second positions A2 and B2. Any or all of the components shown in FIG. 1 can optionally be packaged in a housing. Additional description of housings is provided in Appendices A and B, hereto.

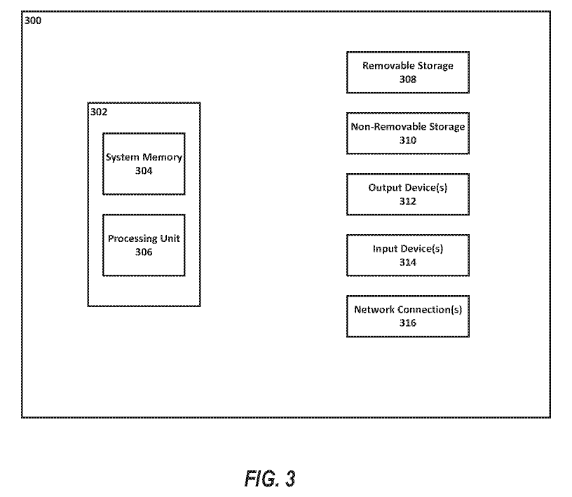

The system 100 can include a controller 104 operably coupled to an imaging device 102 (e.g., by a wired or wireless link). Optionally, the controller 104 can include any or all of the components of the computing device 300 shown in FIG. 3.

The imaging device 102 can optionally be a stereoscopic camera configured to image the scene 150 in three dimensions. Optionally, the imaging device 102 can include any number of cameras in different positions and/or orientations relative to the scene. The imaging device 102 can further be configured to capture images at any time interval. For example, the imaging device 102 can be configured to capture images continuously (e.g., video) or at fixed time intervals (e.g., 1 second, 1 minute, 1 hour, 1 day). As a non-limiting example, the first positions A1 and B1 in FIG. 1 may be from t = 0, and the second positions A2 and B2 may be from t = 1 minute.

Optionally, the imaging device is a camera. The camera can be a 2-D camera module that captures 2-D images (e.g., still images or videos) of the 3-D scene. The camera can optionally be configured for a “live view” constantly acquiring information from the environment. For example, when set up, the user’s room can be is cleaned and a "baseline" can is performed. Then, using computer vision capabilities, the camera can identify objects and items in the room and recognize when they are out of place or have changed status (e.g., bed is unmade, etc.). From this, information and changes to the room are recorded before being translated into digital information, mobile app content, and physical interactions. The camera can also be capable of detecting when a person enters and leaves the room, initiating the scan whenever the person leaves the room. This process is incorporated to promote efficient scanning as well as privacy. To further improve the system's privacy capabilities, the camera can be turned around, acting as a shutter and preventing it from viewing the room, at the user's request. This action is achieved using a motor, which additionally serves as a the mechanism for turning the camera to ensure a full room capture occurs.

The controller 104 can be configured to cause the imaging device 102 to repeatedly image the scene 150 to show changes to the scene 150 over time that can be used to determine what actions should be performed.

For example, the controller 104 can include algorithms that convert the image of the scene 150 into usable information. Inputs can include the type of item, the change that occurred (misplacement, change of status, etc.), and the location of the item in question. With this information, the system is able to pick up on the room's status and convert it into items beneficial to the user, including tasks of various categories, where they are located, when they should be handled, and how long they will take to complete. Additionally, this methodology permits active tracking of the room, allowing the user to be automatically notified of a task as well as have that task "checked off their to-do list" without user input. This information can then be used by the laser indicator, to provide a physical avenue for the system to provide both notification of tasks and encouragement of their completion. This data comprehension and conversion part of the system offers a valuable and innovative characteristic and advantage by gathering information, capturing it digitally, and translating into both useful information for the user and physical means of interaction.

Optionally, the system 100 can further include a directional indicator 106. The directional indicator 106 can controlled by the controller 104 based on the changes to the scene 150. For example, the directional indicator 106 can be controlled to point to objects in the scene that have changed position, or to actions that need to be taken in the scene (e.g., cleaning, repositioning items).

Optionally, the directional indicator 106 can be a laser indicator. This component can include laser diodes attached to a gimbal incorporated into a housing assembly that would be mounted in the corner of the room it is used in. The laser indicator offers full range of motion capabilities, being able to point to any location captured by the camera in the room. The lasers offer several useful functions: notification of where an item/task is located; motivation to complete the task; gamification routes, such as "racing" the system. The housing overall is shaped in a form factor that both easily incorporates the indicator and other components as well as offers an aesthetic appeal so that the system does not interfere with normal home decor. An additional component to the housing is a normal functioning light. This light may not only be for normal illumination purposes, but further can serve as a light source for accurate room scans, a notifier of when a task is to be completed, and even a source for building other healthy habits such as waking up at a specific time.

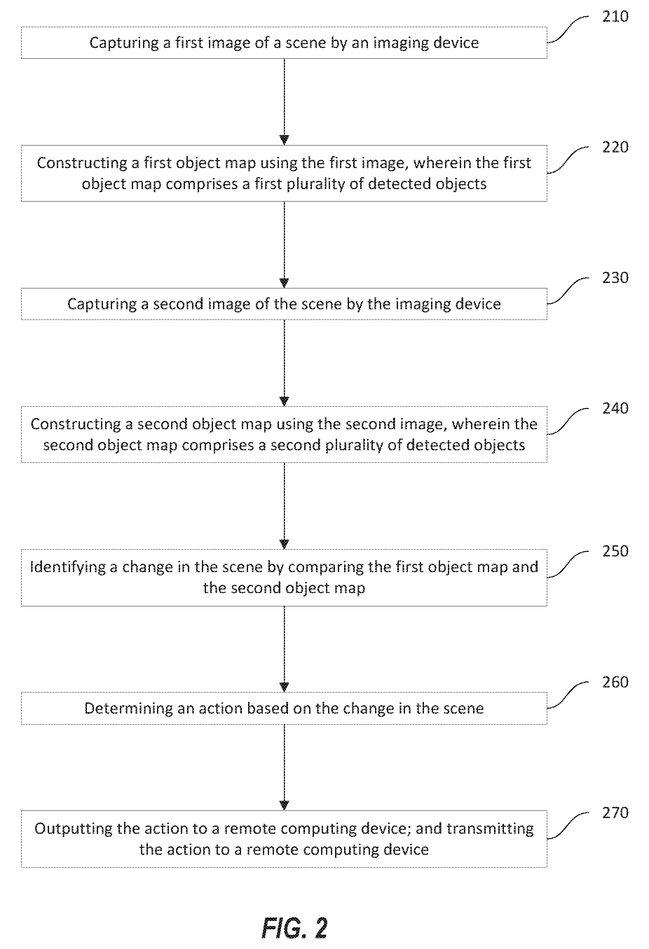

Optionally, the system can further include a remote computing device 108 with a user interface 110 (e.g., a personal computer, laptop, mobile computing device, smartphone). The remote computing device 108 can optionally include any or all of the features of the computing device 300 shown in FIG. 3. The remote computing device 108 can be coupled to the controller 104 through any combination of wired or wireless networks. The controller 104 can transmit any information about the scene 150, including information about changes in the scene 150 and actions determined based on the state of the scene, to the remote computing device 108. As described with reference to FIG. 2, the remote computing device can be configured to display changes to the scene over time and/or any actions determined by the controller 104.

The remote computing device 108 can implement user interface as a mobile application. The device can expand on “To-do” functionalities by offering new features based on the features of the example systems and methods described herein. For example, the features include: a smart task list, which automatically updates when tasks are identified and completed, as well as are optimized into a pre-set schedule for each day for easy planning of completion; a score indicator that helps provide motivation as well as an easy understanding of how much work needs to be completed; a live view tab which provides anytime access and management of a user’s space as well as easy access to seeing what exactly the system is detecting; a task page capable of identifying different categories of tasks and displaying tasks and schedules on differing time frames (day, week, month, etc.); a layout page, capable of providing new room layout suggestions based on criteria such as maximizing space, and improving system function; a social and settings page capable of comparing a user’s efforts to others in the house as well as offering easy control of system preferences.

With reference to FIG. 2, an example method is shown according to implementations of the present disclosure. The system of FIG. 1 can be configured to perform the method described in FIG. 2.

At step 210, the method includes capturing a first image of a scene by an imaging device.

At step 220, the method includes constructing a first object map using the first image, wherein the object map comprises a first plurality of detected objects.

At step 230, the method includes capturing a second image of the scene by the imaging device. Optionally, the method can include detecting that an occupant of the scene (e.g., a person) has left the scene. Alternatively or additionally, capturing the second image of the scene can be initiated by detecting that the occupant has left the scene.

At step 240, the method includes constructing a second object map using the second image, wherein the object map comprises a second plurality of detected objects. Optionally, the method can include constructing the first object map and/or second object map by classifying objects in the image by types (e.g., furniture, clothing, electronics). Alternatively or additionally, the method can include using a machine learning classifier to classify objects in the first and/or second images to create the first and/or second object maps.

At step 250, the method includes identifying a change in the scene by comparing the first object map and the second object map. The first object map can optionally be considered a “baseline” or “original” object map that represents the state of the scene as it is intended to be. The second object map can optionally represent the state of the scene after time has elapsed and the scene has been modified (e.g., by a person in the scene).

At step 260, the method includes determining an action based on the change in the scene. As described with reference to FIG. 1, example actions can include moving items back to their original locations, and cleaning up debris.

At step 270, the method includes outputting the action to a remote computing device. Optionally, the action can be transmitted to a remote computing device, for example by a network. As non-limiting examples, the action can include a task list, reminder, or instruction to the remote computing device which can be displayed by a user interface of the remote computing device (e.g., the user interface 110 shown in FIG. 1). The action transmitted at step 260 can cause the remote computing device to send a reminder by the remote computing device, modify a user interface of the remote computing device, and/or displaying a change in the scene by the remote computing device. For example, if an object captured in the second image has been moved from the baseline position in the first image the action can include returning the object to the baseline position of the first image.

### Example

An example system can capture visual data about a room in a home via a camera and “understand” what is present in the room via computer vision. This data can then betranslated into a set of accomplishable tasks/responsibilities for the user to complete. In addition to understanding what is in the room, the system additionally can understand where objects and items are in a room, what their status is, and whether they are out of place or not at the desired location or level of organization. With this information, the system can additionally translate the information into a physical output via a laser indicator, a spotlight of sorts which identifies changes in the room that the user may or may not be aware of. This component provides the added benefit of physical notification of a task or responsibility and additionally offers motivation for the completion of the task. The example system enables improvements to home management and smart home technology. While the example device is configured for home usage, it could be expanded into other spaces, including retail stores, manufacturing facilities, and distribution centers, as well as other functions, such as inventorying, theft detection, and spatial/process optimization.

It should be appreciated that the logical operations described herein with respect to the various figures may be implemented (1) as a sequence of computer implemented acts or program modules (i.e., software) running on a computing device (e.g., the computing device described in FIG. 3), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 3, an example computing device 300 upon which the methods described herein may be implemented is illustrated. It should be understood that the example computing device 300 is only one example of a suitable computing environment upon which the methods described herein may be implemented. Optionally, the computing device 300 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 300 typically includes at least one processing unit 306 and system memory 304. Depending on the exact configuration and type of computing device, system memory 304 may be volatile (such as random access memory (RAM)), non-volatile (such as read-only memory (ROM), flash memory, etc.), or some combination of the two. This most basic configuration is illustrated in FIG. 3 by box 302. The processing unit 306 may be a standard programmable processor that performs arithmetic and logic operations necessary for operation of the computing device 300. The computing device 300 may also include a bus or other communication mechanism for communicating information among various components of the computing device 300.

Computing device 300 may have additional features/functionality. For example, computing device 300 may include additional storage such as removable storage 308 and non-removable storage 310 including, but not limited to, magnetic or optical disks or tapes. Computing device 300 may also contain network connection(s) 316 that allow the device to communicate with other devices. Computing device 300 may also have input device(s) 314 such as a keyboard, mouse, touch screen, etc. Output device(s) 312 such as a display, speakers, printer, etc. may also be included. The additional devices may be connected to the bus in order to facilitate communication of data among the components of the computing device 300. All these devices are well known in the art and need not be discussed at length here.

The processing unit 306 may be configured to execute program code encoded in tangible, computer-readable media. Tangible, computer-readable media refers to any media that is capable of providing data that causes the computing device 300 (i.e., a machine) to operate in a particular fashion. Various computer-readable media may be utilized to provide instructions to the processing unit 306 for execution. Example tangible, computer-readable media may include, but is not limited to, volatile media, non-volatile media, removable media and non-removable media implemented in any method or technology for storage of information such as computer readable instructions, data structures, program modules or other data. System memory 304, removable storage 308, and non-removable storage 310 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 306 may execute program code stored in the system memory 304. For example, the bus may carry data to the system memory 304, from which the processing unit 306 receives and executes instructions. The data received by the system memory 304 may optionally be stored on the removable storage 308 or the non-removable storage 310 before or after execution by the processing unit 306.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### Example Implementation

An example implementation includes a system configured to capture a series of images of a scene from an imaging device either by a camera as part of the system, or using an external input such as auxiliary camera system such as phone, VR headset or external camera. A scanning algorithm converts the series of images into a plurality of detected objects and a scene layout. Baseline objects and layout are saved as “clean room layout.” A user or person is detected leaving the room and/or a scan is requested by user.

An additional scan can be performed, capturing a new series of images of the same scene from the same imaging device. A scanning algorithm converts the new series of images into a plurality of detected objects and scene layout. These maps can be generated using a series of image captures in different camera positions, and a scanning algorithm. The series of images are merged in order to count detected objects only once per scan. This algorithm assesses the confidence level that a detected object is not only present but correctly classified by the machine learning classifier. New objects and layout are saved as “current room layout,” and a new baseline layout can be created.

A second algorithm can use the output from the scanning algorithm explained previously compares the two layouts to create a task list. The system determines an action based upon the changes in the scans. This can include adding a task to the task list, removing a task from the task list, completing a task in real-time, or scheduling a suggested time to complete any of the previous actions. User routines and habits can be tracked to help optimize schedule/habits/routines by integrating with the user’s current schedule/habits/routines and give suggestions for better schedule/habits/routines.

Suggestions, changes, and actions can be tracked and/or sent to a remote computing device. The device acknowledges the progress and updates the scan, and reflects the changes on the remote computing device. The user can take actions in the scene or take actions on the remote computing device to prompt a new scan or acknowledge a completed action. Alternatively or additionally, the user can add tasks or routines manually to the system task list that are within or not within the visual camera scene. User routines and habits can be tracked to help optimize schedule/habits/routines by integrating with the users’ current schedule/habits/routines and give suggestions for better schedule/habits/routines. The example implementation can further include a game mode and/or task completion mode. When completing a task in the scene, the remote computing device can track the action in real-time.

Game mode can optionally prompt a user to complete tasks in specific order and time frame to motivate user. A real-time “clean” score can track user progress of tasks and routines on the task list to help motivate the user and give real-time feedback. A social score mode can also be included to give users additional motivation to compare their clean score to other users' scores.

The system can optionally include an indicator. The indicator can use the input from the camera to show the user in real-time where the objects are located via a “live view.” This prompts the system to utilize the indicator (laser, projector, visual component, augmented reality, etc.) to visually display in the scene where to move the detected object. The indicator and subsequent algorithm will also detect a path of where the object should go and prompt the user to put it back in that location. The device acknowledges the progress, and the indicator gives visual feedback to the user after the task is complete. These steps can repeat until all tasks are complete.

The system can optionally include layout generation. A third algorithm uses the output from the scanning algorithm explained previously and compares the two layouts to create a room layout change. This change can be optimized based on room spacing, walkway clearance, workflow and overall efficiency. Time optimization of tasks based on a user’s schedule and other events is created to help find time for tasks, optimize time and efficiency of a user’s calendar and overall workflow. The system can also include suggested time intervals for each task and how it can fit into the user’s day. All suggestions, changes, and/or actions can be tracked and/or sent to a remote computing device. The device acknowledges the progress and updates the scan, and reflects the changes on the remote computing device. The system can create a link to a marketplace based on organization and layout suggestions, so that users can purchase items needed to create suggested layouts and room optimization.

The system can further optionally include Important Item Memory, a fourth algorithm that uses the output from the scanning algorithm described herein and utilizes the history of scans to create an “important item” list. The system determines an action based upon the changes in the scans and the habits of the user. This can include: reminding the user of a forgotten item through an alert system, adding an important item, or scheduling a suggested time to complete any of the previous actions. User routines and habits can be tracked to help optimize schedule/habits/routines by integrating with the users’ current schedule/habits/routines and give suggestions for better schedule/habits/routines. The device acknowledges the progress and updates the scan, and reflects the changes on the remote computing device. Any or all suggestions, changes, and actions can optionally be tracked and sent to a remote computing device.

The example implementation can further include safety and security features. Security features can optionally be put in place to ensure the user’s privacy and security. Example security features include: hiding the camera when a scan is not being conducted; minimizing the onboard saving of the video feed; allowing the user to determine when scans occur; and/or storing data locally.

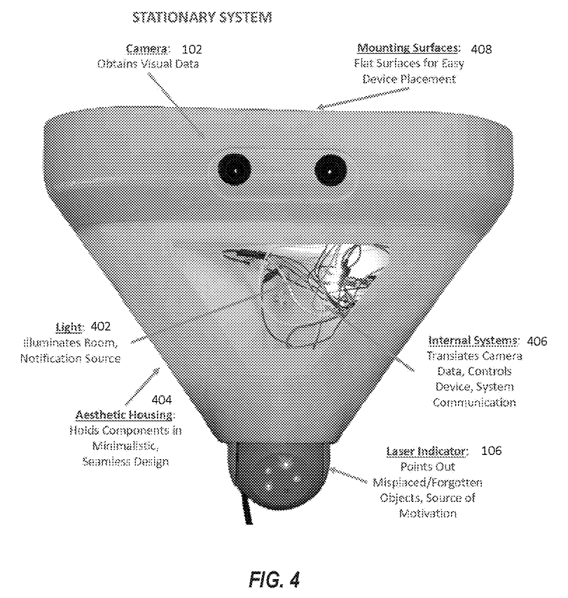

FIG. 4 illustrates an example implementation of the present disclosure implemented as a stationary system. The example shown in FIG. 4 includes an imaging device 102 and directional indicator 106 as described in FIG. 1. The internal systems 406 inside the housing 404 can include the controller 104 described in FIG. 1. Alternatively or additionally, the system shown in FIG. 4 can include mounting surfaces 408 and/or a light 402.

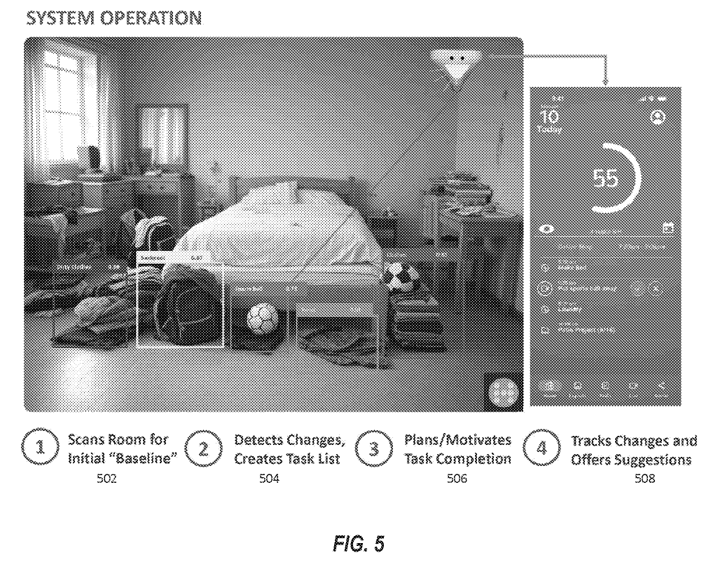

With reference to FIG. 5, an example implementation of the present disclosure includes a graphic showing the system of FIG. 4 in operation. At step 502, the system scans the room to create a “baseline” mapping of the items. At step 504, the system detects changes, for example changes in the positions of items over time. The detected changes at step 504 can be used to create a task list. At step 506, the system creates a plan to complete the tasks to address the detected changes at step 504. At step 508, the system tracks the changes as a user moves items according to the task list (e.g., back to their original locations).

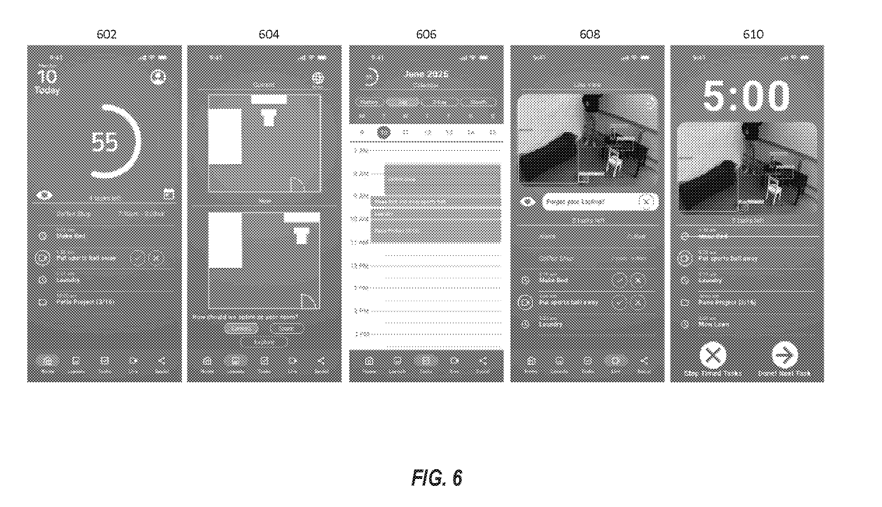

With reference to FIG. 6, an example set of interfaces is shown that can be used to implement the method described in FIG. 5. A first interface 602 displays an example task list. A second interface 604 displays an example interface for optimizing the room. A third example interface 606 displays an example calendar view for scheduling tasks. A fourth interface 608 enables finding of forgotten items. A fifth interface 610 tracks and/or times tasks as they are completed.

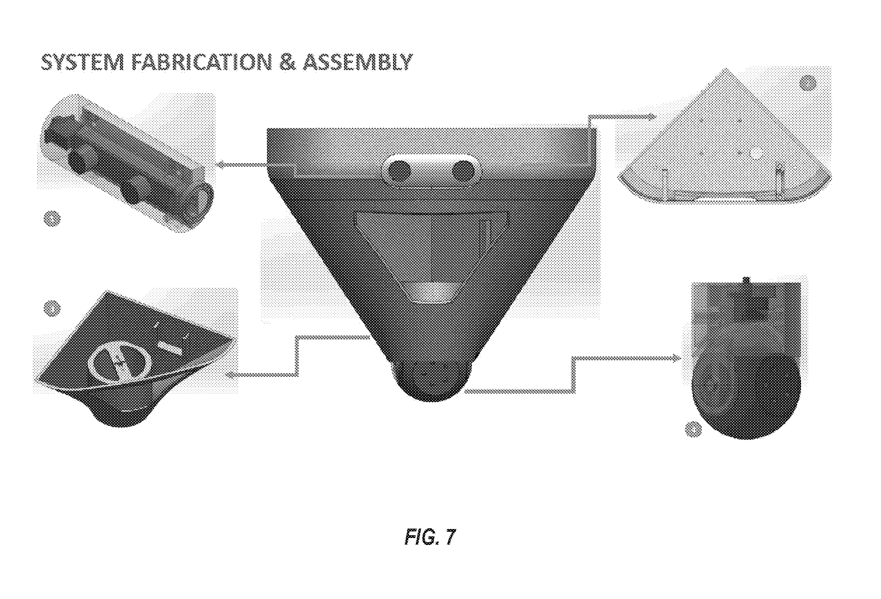

FIG. 7 illustrates example shapes of housing that can be used to implement the system of FIG. 4.

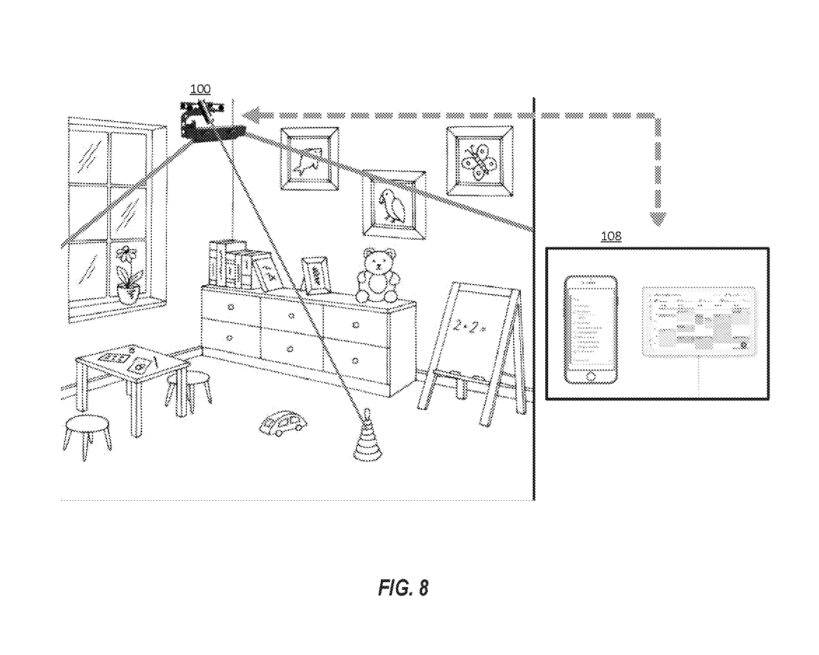

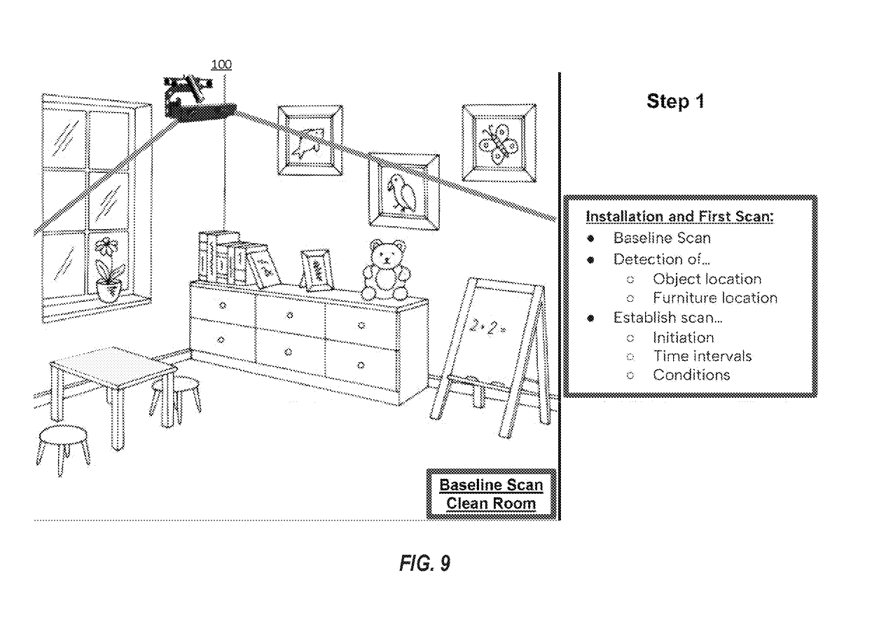

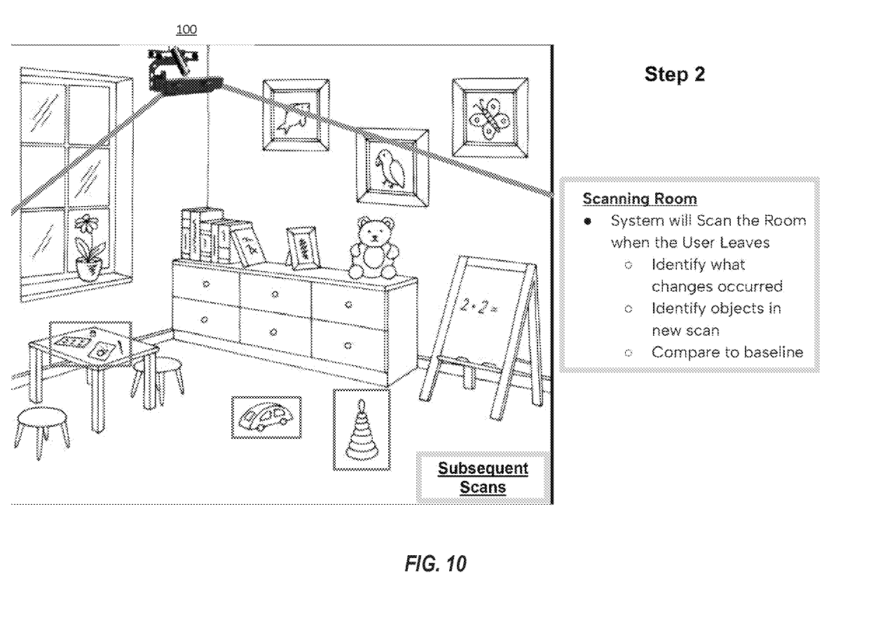

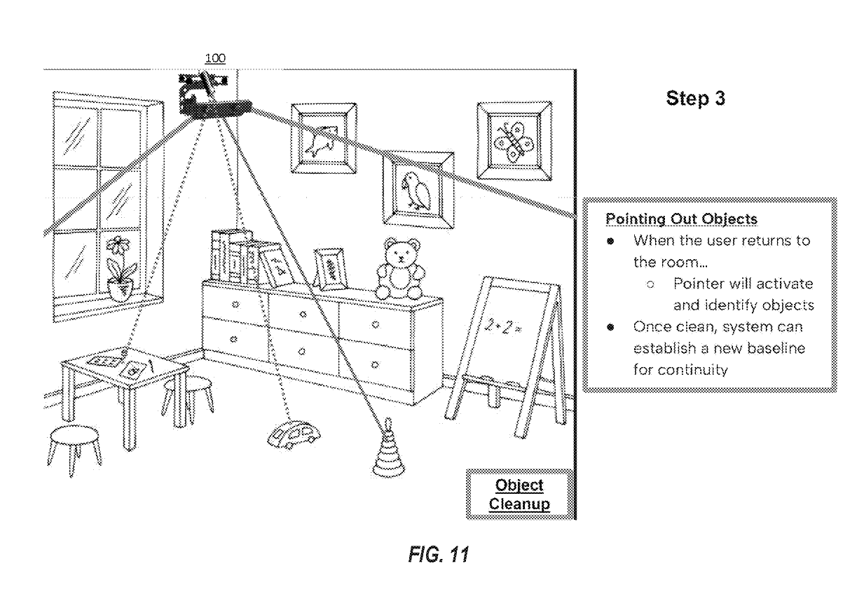

FIGS. 8-11 illustrate another example implementation of the present disclosure in use. FIG. 8 illustrates an example schematic of an implementation of the present disclosure including both a system 100 and remote computing device 108 used with an example scene. FIG. 9 illustrates an example first step where the scene is a clean room, and a baseline scan of the clean room is acquired. FIG. 10 illustrates an example second step where the room is scanned to identify items that have moved from the items’ previous location during the first step shown in FIG. 9. FIG. 11 illustrates an example third step where a “pointer” (e.g., a directional indicator 106 as described with reference to FIG. 1, for example) indicates a location associated with a task or moved object.

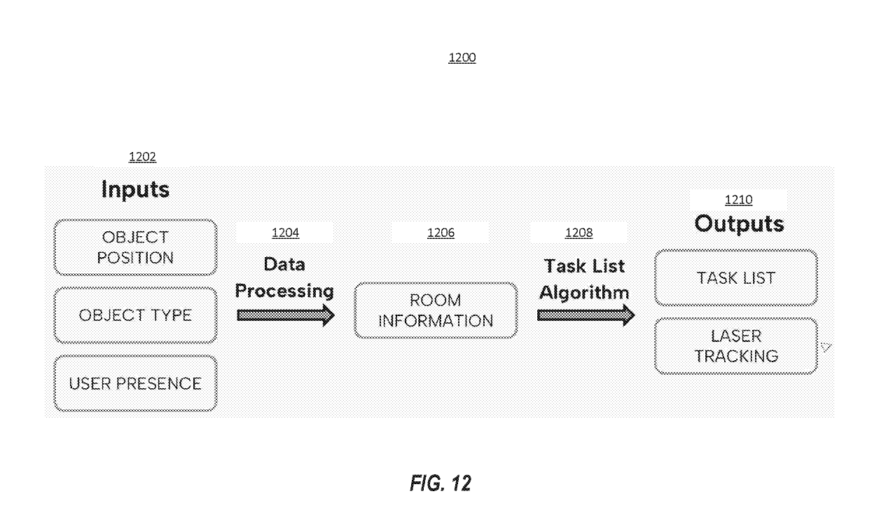

FIG. 12 illustrates an example method that can be performed by any of the systems described herein. At step 1202, inputs are acquired (e.g., object position, object type, and/or user presence). At step 1204, the inputs are processed to generate room information 1206. At step 1208, a task list algorithm is used to generate a task list based on the room information 1206. Optionally, as described herein, the method 1200 can be performed multiple times (e.g., iteratively) so that new room information 1206 can be compared with previous room information 1206 to assess changes in the scene over time. At step 1210, the task list and/or laser tracking can be output, for example to a user’s remote computing device (e.g., smartphone) and/or as controls for a directional indicator 106 as described with reference to FIG. 1.

### Additional Example implementation

While implementations of the present disclosure have been illustrated using home organization, it should be understood that other types of tracking and organization can be performed using the systems and methods described herein. For example, the systems and methods described herein can be used for guiding the organization of any location, including workspaces.

Additionally, the present disclosure contemplates that the imaging device 102 can be used to image a scene 150 including parts that are intended to be assembled (e.g., construction materials or unfinished goods). The controller 104 can generate a task list of actions required to assemble the construction material or unfinished goods into a manufactured product/structure, and update the task list iteratively as the users assemble the materials/goods. The present disclosure further contemplates that the directional indicator 106 can be used to indicate which of the materials/goods are required for a next step of the task list. Thus, it should be understood that the systems and methods described herein for imaging a scene, tracking objects, and generating tasks based on objects are not limited to the specific use cases described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
an imaging device;
a processor and a memory operably coupled to the processor, the memory having computer-executable instructions stored thereon that, when executed by the processor, cause the processor to:
capture a first image of a scene by an imaging device;
construct a first object map using the first image, wherein the first object map comprises a first plurality of detected objects;
capture a second image of the scene by the imaging device;
construct a second object map using the second image wherein the object map comprises a second plurality of detected objects;
identify a change in the scene by comparing the first object map and the second object map;
determine an action based on the change in the scene; and
output the action to a remote computing device.

2. The system of claim 1, wherein the imaging device comprises a 2-D camera module.

3. The system of claim 1, wherein the computer-executable instructions further comprise instructions that, when executed by the processor, cause the processor to: detect that an occupant of the scene has left the scene.

4. The system of claim 1, wherein the remote computing device comprises a mobile computing device.

5. The system of claim 1, wherein the computer-executable instructions further comprise instructions that, when executed by the processor, cause the processor to: classify the first plurality of detected objects and second plurality of detected objects into a plurality of object categories.

6. The system of claim 1, wherein the computer-executable instructions further comprise instructions that, when executed by the processor, cause the processor to: classify the first plurality of detected objects and second plurality of detected objects into a plurality of object categories by a trained machine learning classifier.

7. The system of claim 1, further comprising a directional indicator operably coupled to the processor, wherein the directional indicator is configured to output a directional indication based on the action.

8. The system of claim 7, wherein the directional indicator comprises a laser coupled to a gimbal.

9. The system of claim 1, wherein the first object map comprises a baseline object map, and the second object map comprises a change from the baseline object map.

10. A computer-implemented method comprising:
capturing a first image of a scene by an imaging device;
constructing a first object map using the first image, wherein the object map comprises a first plurality of detected objects;
capturing a second image of the scene by the imaging device;
constructing a second object map using the second image, wherein the object map comprises a second plurality of detected objects;
identifying a change in the scene by comparing the first object map and the second object map;
determining an action based on the change in the scene; and
outputting the action to a remote computing device.

11. The computer-implemented method of claim 10, wherein the imaging device comprises a 2-D camera module.

12. The computer-implemented method of claim 10, further comprising detecting that an occupant of the scene has left the scene.

13. The computer-implemented method of claim 10, wherein the remote computing device comprises a mobile computing device.

14. The computer-implemented method of claim 10, further comprising classifying the first plurality of detected objects and second plurality of detected objects into a plurality of object categories.

15. The computer-implemented method of claim 14, further comprising classifying the first plurality of detected objects and second plurality of detected objects into a plurality of object categories by a trained machine learning classifier.

16. The computer-implemented method of claim 10, further comprising controlling a directional indicator to output a directional indication based on the action.

17. The computer-implemented method of claim 16, wherein the directional indicator comprises a laser coupled to a gimbal.

18. The computer-implemented method of claim 10, wherein the first object map comprises a baseline object map, and the second object map comprises a change from the baseline object map.

19. A non-transitory computer-readable medium having instructions thereon, that when executed by one or more processors, cause the one or more processors to:
capture a first image of a scene by an imaging device;
construct a first object map using the first image, wherein the object map comprises a first plurality of detected objects;
capture a second image of the scene by the imaging device, wherein the object map comprises a second plurality of detected objects;
construct a second object map using the second image;
identify a change in the scene by comparing the first object map and the second object map;
determine an action based on the change in the scene; and
output the action to a remote computing device.

20. The non-transitory computer-readable medium of claim 19, wherein the instructions further comprise instructions that, when executed by the one or more processors, cause the one or more processors to: classify the first plurality of detected objects and second plurality of detected objects into a plurality of object categories by a trained machine learning classifier.
